(19) United States
(12) Patent Application Publication
(10) Pub. No.: US 2004/0153973 A1
(43) Pub. Date: Aug. 5, 2004

(54) System and method for automatically storing and recalling application states based on application contexts

(76) Inventor: Lawrence Horwitz, New York, NY (US)

Correspondence Address: LEFFERT JAY & POLGLAZE, P.A., P.O. BOX 581009, MINNEAPOLIS, MN, 55458-1009, US

(21) Appl. No.: 10/720,033

(22) Filed: Nov. 21, 2003

Related U.S. Application Data
(60) Provisional application No. 60/428,079, filed on Nov. 21, 2002.

(51) Int. Cl. G06F 17/21

(52) U.S. Cl. 715/530

(57) ABSTRACT

A system and method for automatically managing the storing and restoring of application or electronic document states based on the context of an application or electronic document. A state, in this case, refers to all possible settings of an application or electronic document, such as, for example, preference and option settings. A state also refers to the placement and appearance of all the elements that comprise a Graphical User Interface, including palettes, toolbars, menus and so on. When the user takes an action which causes the context of the application to change, the program module detects the change, stores the state of the application and/or electronic document for the context being exited, and restores the previous state of the application and/or electronic document for the context being entered. Thus, every time a user changes a setting in the application or electronic document, such as moving a palette or modifying a user preference, the present invention automatically stores that change and associates it with the current context without any further interaction needed from the user.

### PRIORITY DATA

The present application claims priority to U.S. provisional patent application serial No. 60/416,117 filed on Nov. 21, 2002, and 60/428,079.

### FIELD

The present invention relates generally to computer software, and more particularly to the automatic storage and retrieval of the state of computer software depending on an application's or a document's particular context.

### BACKGROUND

A Graphical User Interface, or GUI, is made up of what are commonly called ‘widgets.’ Widgets can be buttons, checkboxes, scrollbars, menu items, edit boxes or any other graphical element a user can have a direct interaction with using a mouse or other input device. When the user interacts with a widget, generally some result happens. When a user clicks on a bold button in a word processing application, for example, the user expects selected text to become bold.

GUI widgets are generally organized into containers or user-interface elements. There are a variety of different kinds of widget containers. One kind of container is a menu. Menus contain menu items which the user can select to perform some action. Menus are generally organized by category. For example, an edit menu might contain a series of menu items related to editing a document. Menus are generally ‘docked’ along the top of the screen, though in some applications they can be moved to the sides or bottom of the screen.

Another type of container for GUI widgets is a toolbar. A toolbar consists of a series of widgets grouped together, typically lined up one next to the other. Toolbars are also organized by category. An edit toolbar might contain a series of controls that allow the user to edit the contents of a document. Toolbars, like menus, generally appear ‘docked’ at the top of the screen, though in many applications they can be moved to the sides or bottom of the screen.

Another container for GUI widgets is a palette. A palette consists of a series of widgets grouped together in a floating container which can be moved anywhere on the screen. Palettes do not physically connect with any other element on the screen for example, they do not dock into a menu or any other part of the GUI. They float independently. In some applications, toolbars and menus can be ‘torn off,’ or dragged away, from the side of the screen and turned into palettes.

Toolbars, menus and palettes may contain redundant controls. Various controls on a toolbar or palette and menu items in a menu might perform identical operations. This allows a user to interact with the GUI according to his or her preference.

What these three types of widget containers—menus, toolbars and palettes—share in common is that they all have an instant effect. For example, clicking on a bold button will instantly change any selected text to bold. In this sense, menus, toolbars and palettes are called non-modal. The user can have a toolbar up, and can interact with the document or other parts of the application at the same time.

Another kind of widget container is a dialog box. Dialog boxes are similar to palettes in that they are floating windows containing a series of widgets. However, unlike palettes, toolbars and menus, dialog boxes are modal, meaning that when a dialog is up, the rest of the application is locked and inaccessible until the dialog box is dismissed. Changes made to a document or application using a dialog box are generally not applied until an ‘Apply’ or ‘OK’ button is pressed. Some newer applications also allow users to select a ‘Preview’ checkbox, allowing them to see how their changes will affect their work without actually committing to the changes.

When GUIs were first being developed, most of their functionality was hidden in modal dialog boxes. From a user perspective, this created a great disadvantage and inconvenience. A user would have to make changes in the dialog box, click OK, see how the changes looked, and then call the dialog box up again if more changes were needed. This process was tedious and inefficient.

As GUIs evolved, much of the functionality hidden in dialog boxes became exposed in toolbars, menus and palettes. Eventually, this brought about a new problem—a proliferation of toolbars, menus and palettes. In many applications today, there are so many of these non-modal widget containers available that an entire screen can be filled with them, obscuring a document completely.

Practically speaking, there is rarely a user that needs all the toolbars, menus and palettes available in an application at once. Instead, the user calls up the needed widget container when he or she is doing work it is useful for. If, for example, a user is drawing shapes in a word-processing application, the user brings up the drawing palette while they draw. When the user is finished drawing, the palette is dismissed.

However, this frequent invocation and dismissal of toolbars and palettes itself can become a problem. In more sophisticated applications such as those used for desktop publishing or computer graphics, the user may have to interact with different palettes every few clicks. The user must constantly hide and show palettes and toolbars, and must often move palettes around to accommodate new contexts.

Because of these problems, many users choose to keep multiple palettes open at all times. This creates a cluttered user interface which gives the user a limited view of the document they are actually working on.

Palettes, menus and toolbars also pose another problem. In applications which require frequent interaction with palettes, menus and toolbars, the user is constantly moving a cursor from the object in the document being worked on to the needed palette. This forces the user to constantly move the pointer back and forth, either to move the palette to a more convenient location or to access needed widgets. Such constant mouse motion can cause repetitive stress injuries to users. There is therefore a need in the art for GUIs which require less mouse or pointer-device movements.

Users are also faced with the problem of having to manually and repetitively retrieve settings in an application depending on the type of work they are doing. For example, when a user is working with text in a page layout application, they may have a series of settings they prefer for text. When working with graphics, there may be a different series of settings they prefer. These settings may include layout of the GUI as well as such things as default font size, default brush size, and other application specific settings. Having to manually and repetitively change these settings can be tedious, especially when the settings being changed are the same every time. There is therefore a need in the art for a way to automatically save and invoke application settings based on the kind of work the user is doing, which is to say the current context of the application.

Prior art has permitted users to save a series of settings or preferences and recall them at will. Adobe applications, for example, have a feature called ‘Workspaces,’ which allows users to save and restore different palette settings. However, they still have to manually save and invoke these settings, so the problem is simply shifted, not resolved.

Another problem the user is faced with is finding the right toolbar, palette or menu for the problem at hand. Modern-day software applications might offer hundreds of different functions, each with an associated widget or series of widgets. The user might have to invoke and dismiss multiple palettes just to find the widget they need. It can be a tedious, trial and error process. There is therefore also a need in the art for GUIs which automatically organize user-interface elements.

Prior art has tried to address these problems by allowing toolbars and palettes to be customizable. This allows the user to group widgets to his or her liking, but it doesn't resolve the problem of the user having to manually call up specific toolbars and palettes when needed and dismiss them when finished.

Context-sensitive menus, in which a menu appears specifically geared towards the area clicked onscreen, are useful but limited—there are still a large number of unnecessary, and sometimes disabled, menu items available at any given time. Context-sensitive menus are also only applicable to menus, not to toolbars and palettes.

Some applications, such as the Microsoft Office suite, only show the most recently used menu items. This only hides from the user the most infrequently used menu items. This method is not sensitive to context. It may show some menu items which are not relevant to the current context, while hiding others that are.

In patent application publication number 20020101450[2002], Microsoft Corp. proposes what is essentially one all-purpose palette whose contents shift as the user changes context within the application or document. First, the Microsoft proposal creates a shifting palette layout which can confuse users. Microsoft proposes a single palette whose contents and layout constantly shift. In many applications, especially those relating to the graphic design and computer animation fields, users are accustomed to and even dependent on palettes whose layout and content remain the same. Second, the Microsoft proposal does not take into account screen location. For the applications that Microsoft makes, screen location is not as critical as it is in desktop publishing, web design or other visual design applications where frequent pointer movement can lead to repetitive stress injury. Third, the architecture of the Microsoft proposal is geared primarily towards applications that allow customizing individual palettes.

Finally, it should be noted that Microsoft is not the first company to come up with the idea of a palette whose contents change as application or document context changes. The measurements palette in QuarkXPress has been displaying such behavior since the early 1990s.

Application users have a need for different settings in different contexts, particularly in more sophisticated applications such as computer graphics or desktop publishing. Different users have very different needs in the different application or document contexts—allowing them the ability to only modify certain settings is insufficient. There is a need in the art for a system that allows users to have any and all user settings saved and restored automatically.

Prior art has addressed the idea of modifying an application's interface based on context. In some applications, for example, a certain toolbar is only visible when the user enters a context in which it would be useful. However, those applications will only show and hide those widgets which are exclusive to that particular context. For example, in Microsoft Word, when editing a document outline, the Outline toolbar appears, and it disappears when the user is not in outline mode. However, there is no way to get the formatting toolbar, for example, to appear and disappear, or to have it change locations, when the user enters or exits Outline mode, even though the user rarely does formatting in outline mode. So those automatic modifications based on context that exist in prior art are limited to those widgets exclusive to a context.

### SUMMARY

The various embodiments of the present invention provide systems and methods for automatically collecting and storing application and document settings by examining an application's state when the user exits any particular context, and then restore the application and document state when the user re-enters that context. All features of the invention can be enabled or disabled individually or globally as the user wishes.

The invention can be embodied as a program module interacting with a specific application via that application's API, as a program module interacting with several applications via a shared code library, or as a program module which is actually contained in the main application's executable code.

Other embodiments are described and claimed.

### BRIEF DESCRIPTION OF DRAWINGS

FIG. 1 is a block diagram depicting an embodiment in which a program module interacts with an application's Application Programming Interface (API).

FIG. 2 is a block diagram depicting an embodiment in which a program module is actually contained within a main program's executable code.

FIG. 3 is a block diagram depicting an embodiment in which a single program module interacts with a code library shared by multiple applications.

FIGS. 4-6 depict one possible implementation of the current invention.

FIG. 7 is a flow chart diagram for automatically storing and restoring document and application states according to another embodiment of the present invention.

### DETAILED DESCRIPTION

In the following detailed description of the invention, reference is made to the accompanying drawings that form a part hereof, and in which is shown, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, logical, and electrical changes may be made without departing from the scope of the present invention.

The following detailed description is, therefore, not to be taken in a limiting sense, and the scope of the present invention is defined only by the appended claims, along with the full scope of equivalents to which such claims are entitled.

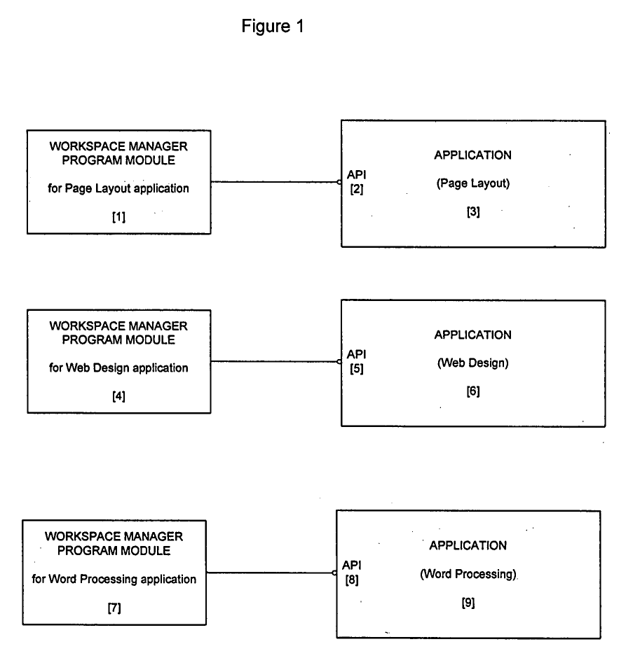

FIG. 1 depicts an embodiment in which a program module interacts with a specific application's Application Programming Interface (API). In this embodiment, the APIs for each application may be very different. Thus, the program module is designed for each specific API. As a result, a different program module is used for each application.

A page layout application 3 has its own API 2 providing other applications programmatic access. A program module 1 has been designed and implemented to manage the user interface for this specific application.

Similarly, a web design application 6 has its own API 5 which requires a separate program module 4 be written to manage the user interface.

Further, a word processing application 9 might have yet another API 8 requiring yet another program module 7 be written to that API.

One advantage of this embodiment is that a program module can be written for already existing applications using the API. The program module need not have been created at the same time as the application. A new program module must be written for each application.

The definition of what makes up an “application or document context” is determined by the program module, and will change from one application domain to another. For word processing applications, for example, checking spelling may be one context, and highlighting text in preparation for formatting may be another context. In a page layout application, clicking on a text box may be one context, while clicking on a picture box may be another context. In a web design application, visually creating a page may be one context, while editing HTML code may be another context.

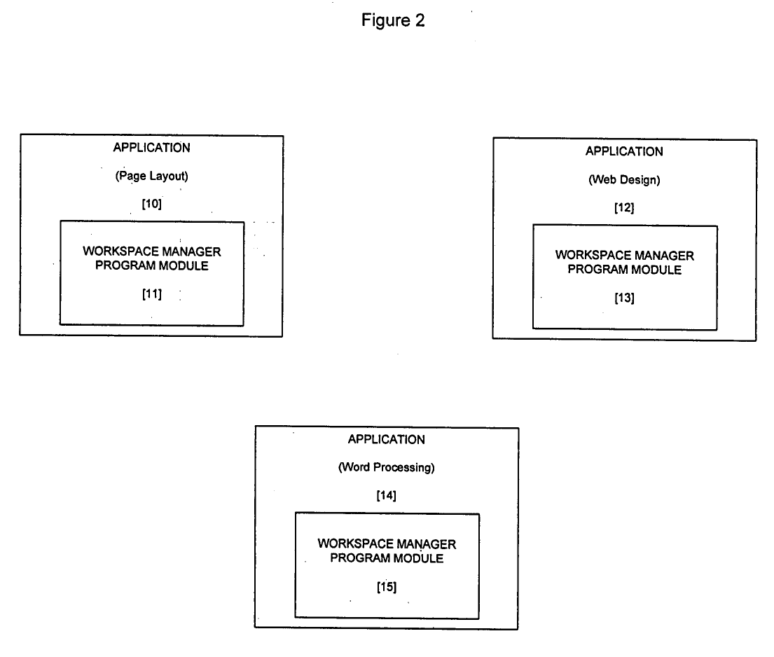

FIG. 2 depicts another embodiment, in which page layout 10, web design 12 and word processing 14 applications have each incorporated into their main executable code block program modules for managing user interface states (11, 13 and 15, respectively). In this embodiment, similar to FIG. 1, a separate program module is written for each application, but unlike the embodiment of FIG. 1, the program module is created at the same time as the application and is incorporated into the main executable for the program. The program module cannot be separated from the main code base. One advantage to this embodiment is that the program module has full access to the application's internal data, and is not limited to the interface provided by an API. The program module cannot be modified independently of the application.

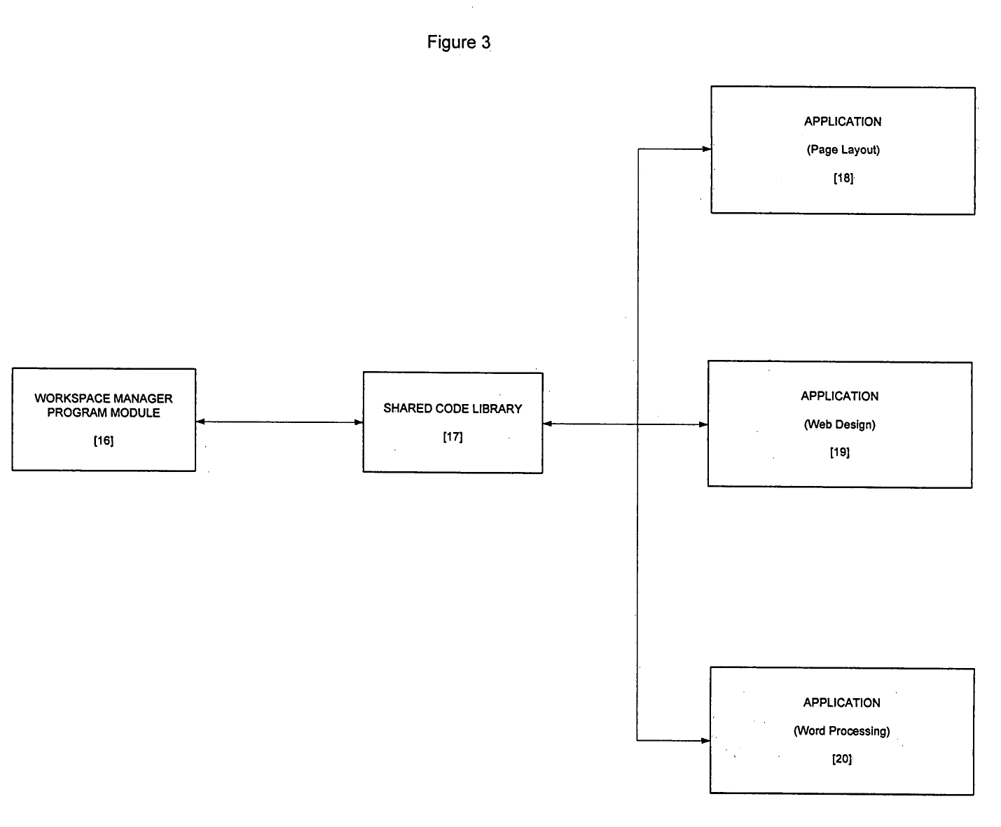

FIG. 3 depicts another embodiment, in which one program module 16 is written for multiple applications [18, 19 and 20] using a code library 17 shared by all three applications. This embodiment has as one advantage requiring only one program module to be written for multiple applications, and is especially practical for applications which come from the same vendor and offer a public shared code library.

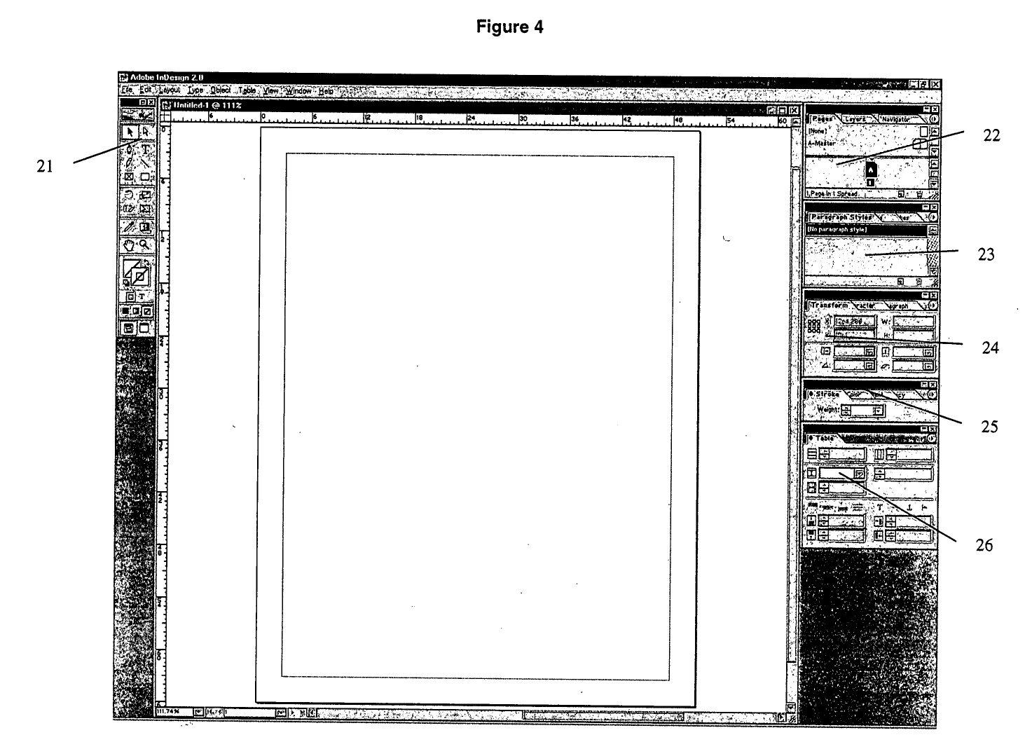

FIGS. 4-6 illustrate one possible embodiment of the current invention in Adobe InDesign, a desktop publishing application. Although these figures focus on the way that application states are changed by moving around palettes, the present invention applies to any possible setting in an application or electronic document, including but not limited to: location and layout of menus, toolbars, buttons, checkboxes, and any other user interface widget; preference settings such as units of measurement or snap to grid; and domain-specific settings such as brushstroke size or dictionary language.

FIGS. 4-6 shows how the present invention can distinguish between document contexts. The contexts in this case are: working no page items selected, working with text or working with graphics.

FIG. 4 illustrates the case of working with no page items selected. The user has launched InDesign and has not created anything on the page. The application is in its default state. The Tools palette 21, Pages palette 22, Paragraph Styles palette 23, Transform palette 24, Stroke palette 25 and tabs palette 26 are all showing.

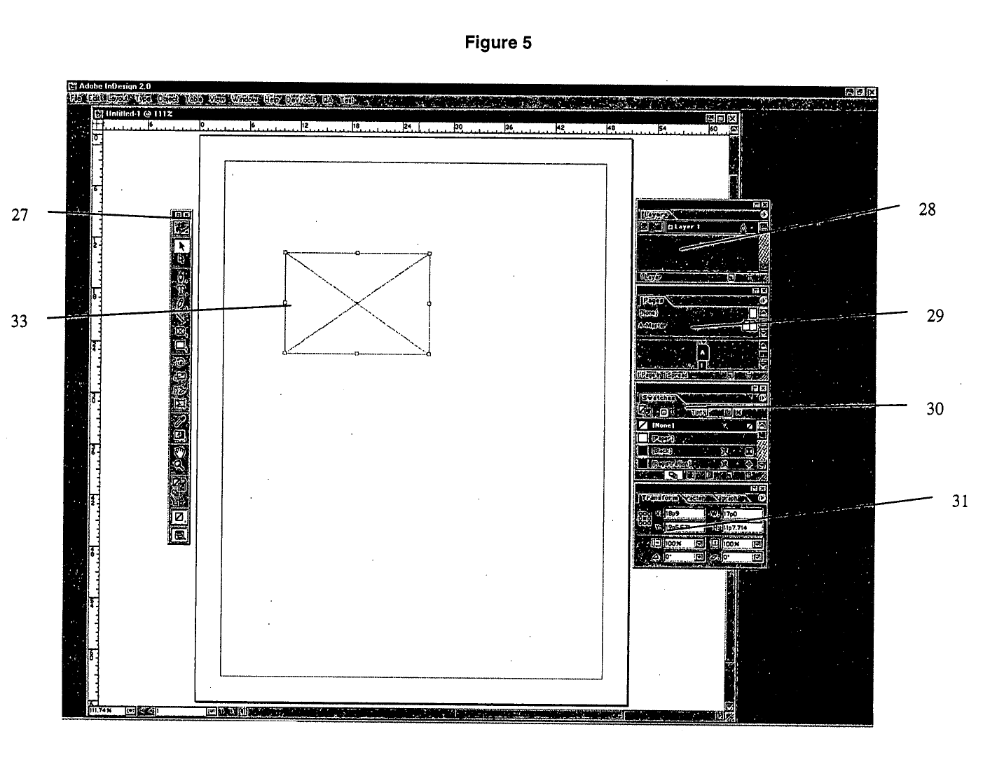

FIG. 5 illustrates the case of working with graphics. The user has changed context by creating a picture box 33 and selecting it. The user has also modified the application's state by moving palettes around. The Tools palette 27 has been moved and its layout has been changed. The Layers panel has been separated into its own palette 28 and moved. The Pages panel has also been separated into its own palette 29 and moved. The Swatches panel has been separated into its own palette 30 and moved. The Transform panel 31 has been moved.

When the user exits the application state in which a picture box is selected, the program module will store the state of the application and associate it with the context of working with graphics. The next time the context of working with graphics is entered, this application state will then be recalled and restored.

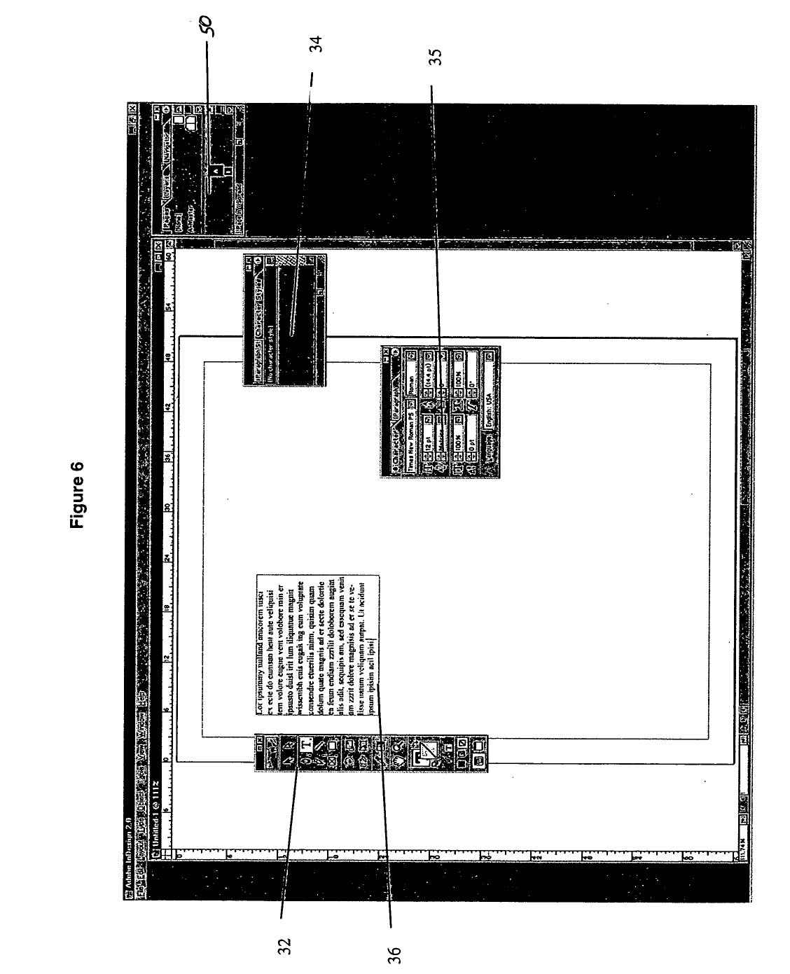

FIG. 6 illustrates the case of working with text. The user has created and selected a text box 36. The user has moved the Tools palette 32 and changed its layout. The layout has also recombined different panels and now shows the Pages 50, Character Styles 34, and Character 35 panels. Note that the Character and Paragraph panels have been combined into a single palette 35. All of the palettes have been moved.

When the user exits the context of working with text, the program module records the state of the application and document and associates with the context of working with text. For example, the fact that the Character and Paragraph panel are combined in the same palette is recorded. When the user re-enters this context by working with text again, then the current application state is restored.

If from here the user were to click on a picture box, the palette layout as illustrated in FIG. 6 is stored as the application state for working with text and application state illustrated in FIG. 5 is called up and restored since the user is beginning to work with graphics.

It should be understood that the embodiments shown in FIGS. 4-6 are only representative of the types of applications on which embodiments of the present invention are applicable. As has been mentioned, the concepts of the present invention are applicable to any type of program that has a user interface or that allows users to create application or document settings.

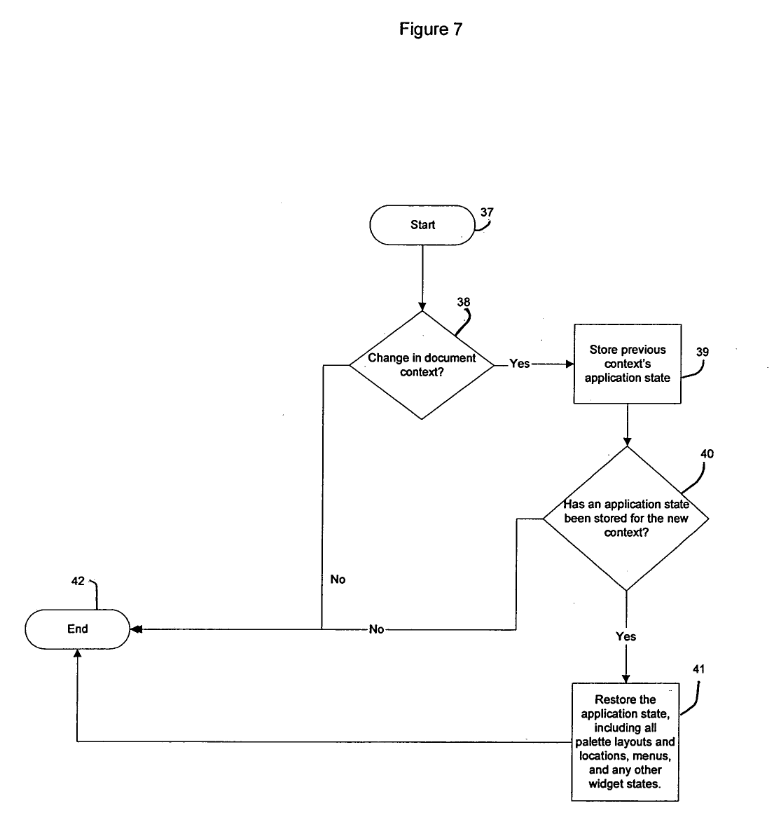

FIG. 7 is a flow chart diagram of a method for automatically storing and restoring document and application states according to another embodiment of the present invention. The method begins at decision block 38.

In block 37 the program module is notified of a change in the application or document. The program module examines this change in decision block 38. Typically, the application sends notification of some change to the program module. The program module is then responsible for examining that change to determine if it constitutes a change in context that interests it. What defines an ‘interesting’ change in context is determined by the program module itself and may vary from one application domain to the next. Some examples of user changes which a program module might consider changes in context include changes to a document's content, changes to the current selection, or a change in focus in the application from one GUI widget to another.

If the program module decides that there is no change to the context, the process ends at block 42. If there is a change, the program module then stores the application's and document's current state, including the state of all palettes, menus, toolbars and other widgets, as well as any other settings the user can set, in block 39. This stored application and document state are associated with the context being exited. The state will then be restored later when the context is re-entered.

In decision block 40, a determination is made as to whether any application and document state for the new context has been previously stored. If there is no stored state, the process ends at block 42. If there is, the process continues at block 41.

In block 41, the program module restores the application and document state for the new context that had been previously stored. This includes restoring the state and location of all palettes, menus, toolbars and any other GUI widgets or elements, as well as restoring any other document and application settings that can be changed.

The process then finishes at block 42.

### Conclusion

Embodiments of the present invention take all application and document settings and user interface elements and automatically store their state in some persistent data storage media upon exit from a context and restore their state from some persistent data storage media upon entry into a context. Restoring an application state might include changing the layout of the user interface and changing settings of user interface elements. It might also include changing any other settings that are possible to set in an application or document.

Advantages of the embodiments of the present invention include by way of example only and not by way of limitation, providing a program or other service whereby palettes, menus and toolbars are automatically shown or hidden depending on the application or document context the user invokes, reducing on-screen clutter and making it easier for a user to find needed functionality; and offering a service whereby palettes are automatically moved to a users preferred state, reducing the amount of mouse or input-device movement the user must go through, making the GUI physically safer from repetitive stress injuries. The present invention also offers the advantage of allowing the user to automatically have settings specifically useful to a certain context automatically drawn up without manual effort from the user, saving the user work and time.

The present invention has been described in relation to particular embodiments which are intended in all respects to be illustrative rather than restrictive. Alternative embodiments will become apparent to those skilled in the art to which the present invention pertains without departing from its scope. Accordingly, the scope of the present invention is defined by the appended claims rather than the foregoing description.

What is claimed:

1. A method for automatically storing and restoring the state of an application and/or electronic document according to a context change in said application program or electronic document, comprising:
determining a previous context for said application program and/or electronic document;
collecting a current state of said application and/or electronic document;
associating said current sate with said previous context and storing said current state;
determining a new context for said application program and/or electronic document;
recalling the previously stored state for said new context; and
restoring said previously stored state to said application and/or electronic document.

2. The method of claim 1 wherein said current and previously stored states of said application and/or electronic document include but are not limited to the state of a plurality of user interface elements, including but not limited to windows, buttons, menu items, text boxes, toolbars, palettes, icons, scrollbars and sliders.

3. The method of claim 2, wherein said state includes but is not limited to screen location of said user interface elements, size of said user interface elements, layout of said user interface elements, and any state specific to a certain type of said user interface elements.

4. The method of claim 2, and further comprising choosing which user elements should have said state persisted.

5. The method of claim 1 wherein said previous and current contexts are determined by the content types being edited, where said content types include but are not limited to text, raster images, vector graphics, audio content, video content, or proprietary content.

6. The method of claim 1 wherein said previous and current contexts are determined by changes to the user interface, including but not limited to selecting a user interface tool or changing a view of a document.

7. The method of claim 1 wherein the user is presented an interface for defining said current and previous states.

8. The method of claim 7, wherein said interface comprises a dialog box listing all possible settings which can comprise said current and previous states.

9. The method of claim 7, wherein said interface comprises context sensitive menus listing all possible settings which can comprise said current and previous states.

10. A method for automatically customizing a user interface in an application program according to changes in contexts of said application program or of an electronic document being modified by said application program, comprising:
determining a previous context for said application program and/or electronic document;
collecting a current user interface state of said application and/or electronic document;
associating said current sate with said previous context and storing said current state;
determining a new context for said application program and/or electronic document;
recalling the previously stored user interface state for said new context; and
based upon said previously stored user interface state, invoking, resizing, resetting, moving and/or dismissing pre-existing windows, buttons, menus, text boxes, toolbars, palettes, icons, scrollbars and/or sliders.

11. The method of claim 10, wherein users are presented with an interface allowing them to choose which of said contexts are enabled or disabled

12. The method of claim 11, wherein said interface consists of a dialog box listing all contexts in an application.

13. The method of claim 10, wherein, by way of example only and not by way of limitation, said contexts might be defined by what type of content is being edited, what kind of user interface element is selected, what type of network is being connected to, or what kind of window is open.

14. A machine readable medium having a set of machine readable instructions for causing a computer to perform a method for automatically storing and restoring the state of an application and/or electronic document according to a context change in said application program or electronic document, the method comprising:
determining a previous context for said application program and/or electronic document;
collecting a current state of said application and/or electronic document;
associating said current sate with said previous context and storing said current state;
determining a new context for said application program and/or electronic document;
recalling the previously stored state for said new context; and
restoring said previously stored state to said application and/or electronic document.
